(19) United States
(12) Patent Application Publication
(10) Pub. No.: US 2016/0223894 A1
(43) Pub. Date: Aug. 4, 2016

(54) LASER LIGHT SOURCE DEVICE AND IMAGE PROJECTION DEVICE

(71) Applicant: USHIO DENKI KABUSHIKI KAISHA, Tokyo (JP)

(72) Inventor: Hirotaka YAMADA, Himeji-shi (JP)

(73) Assignee: USHIO DENKI KABUSHIKI KAISHA, Tokyo (JP)

(21) Appl. No.: 14/916,010

(22) PCT Filed: Aug. 21, 2014
(86) PCT No.: PCT/JP2014/071893

§ 371 Date: Mar. 2, 2016

(30) Foreign Application Priority Data
Sep. 5, 2013 (JP) 2013-183755

(51) Int. Cl. G03B 21/20; H04N 9/31; G02B 27/10; G02B 27/48

(52) U.S. Cl. CPC G03B 21/2013; G03B 21/2033; G02B 27/48; G03B 21/208; H04N 9/3161; G02B 27/106

(57) ABSTRACT

A laser light source device (2) is provided with a plurality of laser light sources (21) from which laser light beams exit, an optical system (22) on which light beams exited from the plurality of laser light sources (21) are incident, and a light guide body (23) having an incident surface (23a) on which light beams exited from the optical system (22) are incident, at least two of the plurality of laser light sources (21) exit light beams having the same wavelength, and at least two of the light beams having the same wavelength are different in an incidence angles of an optical axis to the incident surface (23a).

### TECHNICAL FIELD

The present invention relates to a laser light source device provided with a plurality of laser light sources exiting laser beams and further relates to an image projection device provided with a laser light source device.

### BACKGROUND ART

In the prior art, as a laser light source device, there has been known a laser light source device in which laser beams exited from a plurality of laser light sources are incident on an optical fiber and so on (for example, Patent Document 1). In addition, there has been known a technique in which light exited from this laser light source device is used as a light source of a light source device for light exposure, a projector, or the like. In this technique, noise with the intensity of light, which is called speckle noise, occurs on a laser beam irradiation surface or on the retinas of an observer.

Thus, Patent Document 1 proposes the laser light source device in which, in order to reduce speckle noise, at least one of a plurality of laser light sources exits light having a wavelength different from that of light exited from other laser light sources. However, in the laser light source device according to Patent Document 1, since there is a limit to a usable wavelength range, there is a problem that a sufficient reduction in speckle noise (also referred to as a “despeckle effect” or “reduction in speckle contrast”) cannot be achieved.

### PRIOR ART DOCUMENTS

### Patent Documents

Patent Document 1: JP-A-2004-146793

### SUMMARY OF THE INVENTION

### Problems to be Solved by the Invention

Accordingly, in view of the above circumstances, an object of the present invention is to provide a laser light source device and an image projection device which can achieve a sufficient reduction in speckle noise.

### Means for Solving the Problems

According to the present invention, there is provided a laser light source device, which includes:

a plurality of laser light sources from which laser beams exit; and

a light guide body having an incident surface on which the light beams exited from the plurality of laser light sources are incident,

wherein at least two of the plurality of laser light sources exit light beams having the same wavelength, and

in at least two of the light beams having the same wavelength, incidence angles of optical axes to the incident surface are different.

Also, there is provided a laser light source device, which includes:

a plurality of laser light sources from which laser beams exit; and

an optical system on which light beams exited from the plurality of laser light sources are incident and which exits the light beams toward an incident surface of a light guide body,

wherein at least two of the plurality of laser light sources exit light beams having the same wavelength, and

the plurality of laser light sources and the optical system are configured that in at least two of the light beams having the same wavelength, incidence angles of optical axes to the incident surface are different.

According to the present invention, light beams exited from a plurality of laser light sources are incident on an incident surface of a light guide body. At least two laser light sources exiting light beams having the same wavelength are provided, and light beams exited from at least two of these laser light sources are different in an incidence angle of an optical axis to the incident surface. Consequently, speckle noise can be reduced.

Also, the laser light source device according to the present invention may have a configuration in which:

the light beams having the same wavelength, the incidence angles of the optical axes to the incident surface are all different.

According to the above configuration, at least two laser light sources exiting light beams having the same wavelength are provided. In the light beams exited from those laser light sources, the incidence angles of the optical axes to the incident surface are all different. Consequently, the speckle noise can be more effectively reduced.

Also, the laser light source device according to the present invention may have a configuration in which:

the light beams exited from at least two of the plurality of laser light sources, the incidence angles of the optical axes to the incident surface are equal, and the at least two laser light sources exit light beams having different wavelengths.

According to the above configuration, at least two laser light sources exiting light beams in which the incidence angles of the optical axes to the incident surface are equal are provided. At least two of those laser light sources exit light beams having different wavelengths. Consequently, a sufficient amount of light is allowed to be incident on the light guide body, and, at the same time, the occurrence of the speckle noise can be reduced.

Also, the laser light source device according to the present invention may have a configuration in which:

the light guide body is an optical fiber or a rod integrator.

Also, there is provided an image projection device, which includes:

at least one the laser light source device and using a light beam exited from the laser light source device as projection light.

### Effect of the Invention

As described above, the present invention provides such an excellent effect that a sufficient reduction in speckle noise can be achieved.

### BRIEF DESCRIPTION OF THE DRAWINGS

FIG. 1 is a schematic configuration diagram of an image projection device according to one embodiment of the present invention.

FIG. 2 is a schematic configuration diagram of a laser light source device according to the same embodiment.

FIG. 3 is a view for explaining an incident pattern of light being incident on an optical system according to the same embodiment.

FIG. 4 is a view for explaining an incidence angle of light on an incident surface of a light guide body according to the same embodiment.

FIG. 5 is a view for explaining “different wavelengths” according to the same embodiment.

FIG. 6 is a view for explaining “different wavelengths” according to the same embodiment.

FIG. 7 is a view for explaining an effect when light beams having the same wavelength are incident on the incident surface of the light guide body at different angles and is a view showing an incident pattern of light being incident on the optical system.

FIG. 8 is a view for explaining an effect when light beams having different wavelengths are incident on the incident surface of the light guide body and is a view showing an incident pattern of light being incident on the optical system.

FIG. 9 is a view for explaining an incident pattern of light being incident on an optical system according to another embodiment of the present invention.

FIG. 10 is a view for explaining an incident pattern of light being incident on an optical system according to still another embodiment of the present invention.

### MODE FOR CARRYING OUT THE INVENTION

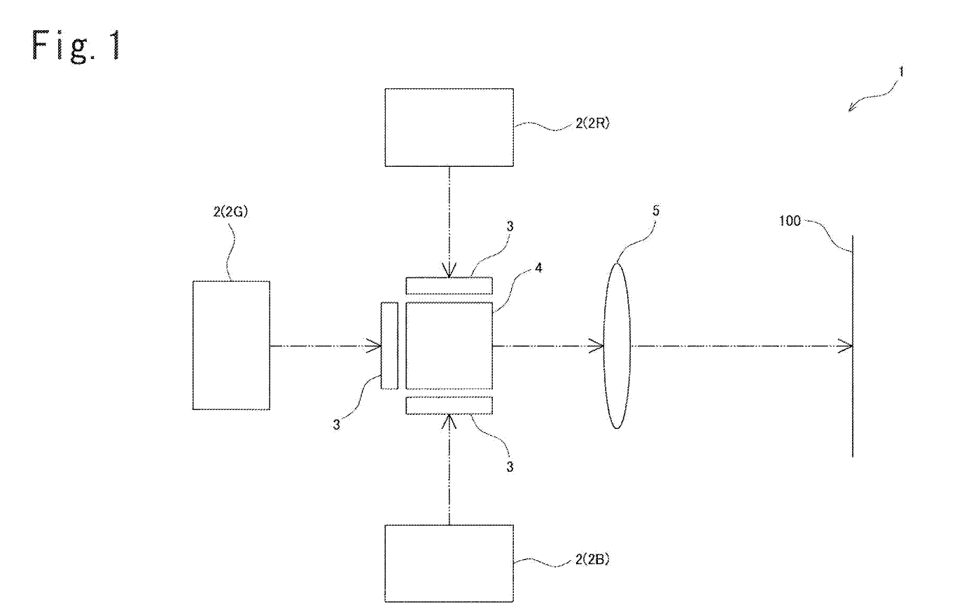

Hereinafter, one embodiment of a laser light source device and an image projection device according to the present invention will be described by referring to FIGS. 1 to 8.

As shown in FIG. 1, an image projection device 1 according to this embodiment is provided with a plurality of (three in this embodiment) laser light source devices 2 (2R, 2G, and 2B) exiting light beams of different colors and spatial modulation elements 3 which each convert a light beam exited from each of the laser light source devices 2 into an optical image. The image projection device 1 is further provided with a color synthesis optical element 4, which synthesizes the optical image exited from each of the spatial modulation elements 3, and an optical image projection mechanism 5 which projects the optical image exited from the color synthesis optical element 4 onto a screen 100 while enlarging the optical image.

The laser light source device 2 is provided with a first laser light source device 2R exiting a laser beam of a first color (for example, red), a second laser light source device 2G exiting a laser beam of a second color (for example, green), and a third laser light source device 2B exiting a laser beam of a third color (for example, blue). The spatial modulation element 3 is constituted of, for example, a digital micromirror device or a liquid crystal display device, the color synthesis optical element 4 is constituted of, for example, a color synthesis prism such as a dichroic prism, and the optical image projection mechanism 5 is constituted of, for example, a projection lens.

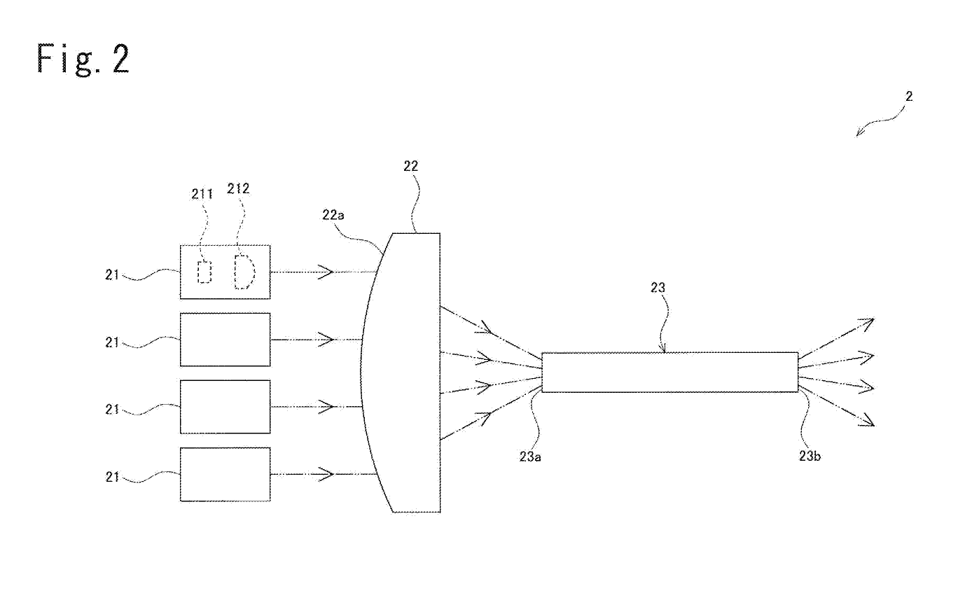

As shown in FIG. 2, the laser light source device 2 according to this embodiment is provided with a plurality of laser light sources 21 exiting laser beams, an optical system 22 on which the light beams exited from the plurality of laser light sources 21 are incident, and a light guide body 23 having an incident surface 23a on which light beams exited from the optical system 22 are incident. In the laser light source device 2, light exited from the light guide body 23 is incident on the spatial modulation element 3.

The laser light source 21 is provided with a semiconductor laser 211 which exits laser light and a collimate lens 212 which converts the laser light exited from the semiconductor laser 211 into parallel light. The plurality of laser light sources 21 are arranged so that optical axes of exited light beams are parallel to each other when being incident on at least the optical system 22.

In addition, the plurality of laser light sources 21 are arranged so that the optical axes of exited light beams are located at different positions on an incident surface 22a of the optical system 22. Preferably, the plurality of laser light sources 21 (in particular, the laser light sources 21 outputting light beams having the same wavelength) are arranged so that exited light beams do not overlap each other on the incident surface 22a of the optical system 22.

The plurality of laser light sources 21 exit light beams having a plurality of wavelengths. In this embodiment, nine laser light sources 21 are provided (in FIG. 2, only four laser light sources 21 are illustrated). For example, in the second laser light source device 2G, three laser light sources 21 exiting light having a first wavelength (for example, the wavelength of 530 nm), three laser light sources 21 exiting light having a second wavelength (for example, the wavelength of 532 nm), and three laser light sources 21 exiting light having a third wavelength (for example, the wavelength of 534 nm) are provided.

In this embodiment, the optical system 22 is used as a condensing lens which condenses light, exited from the plurality of laser light sources 21, toward the center of the incident surface 23a of the light guide body 23. In other words, the optical system 22 changes the direction of the optical axis of light exited from each of the laser light sources 21 toward the center of the incident surface 23a of the light guide body 23 (the optical system 22 deflects the optical axis of the light).

The light guide body 23 is formed to be long, and while the planar incident surface 23a is disposed at one end, and a planar exit surface 23b is disposed at the other end. The light guide body 23 is configured to reflect all light beams on its side surface and thereby propagate the light beams along the longitudinal direction while holding the angles at which the light beams being incident on the incident surface 23a advance.

In this embodiment, the light guide body 23 is an optical fiber constituted of a core as a center core, a clad disposed outside the core and having a refractive index lower than that of the core, and a coating covering the clad (only the core is illustrated). Namely, the incident surface 23a is constituted of a surface on one end side of the core. The light guide body 23 is not limited to an optical fiber and may be, for example, a rod integrator.

Here, there will be explained light incidence angle and incident position in the incident surface 23a of the light guide body 23 according to arrangement of each of the laser light sources 21 (light incident position to the optical system 22) and the action of the optical system 22.

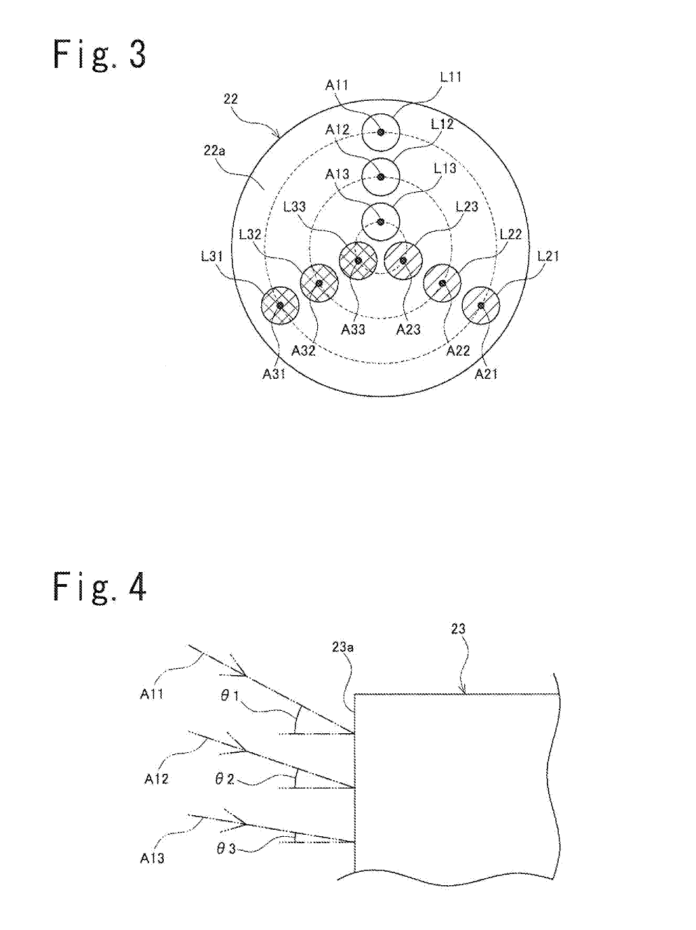

As shown in FIG. 3, light beams L11, L12, and L13 having the same first wavelength are exited from three laser light sources 21. Further, light beams L21, L22, and L23 having the same second wavelength are exited from the three laser light sources 21. Furthermore, light beams L31, L32, and L33 having the same third wavelength are exited from the three laser light sources 21. FIG. 3 shows the incident position of each of the light beams L11 to L13, L21 to L23, and L31 to L33 to the incident surface 22a of the optical system 22.

In this embodiment, the optical system 22 condenses light from the laser light source 21 toward the center of the incident surface 23a of the light guide body 23. Accordingly, when the optical axes of light beams exited from the laser light source 21 are located at different distances from the center on the incident surface 22a of the optical system 22, the incidence angles of the optical axes to the incident surface 23a of the light guide body 23 are different.

For example, in L11, L12, and L13 which are the light beams having the same first wavelength, optical axes A11, A12, and A13 are located at different distances from the center on the incident surface 22a of the optical system 22. Accordingly, in L11, L12, and L13 which are the light beams having the same first wavelength, as shown in FIG. 4, incidence angles θ1, θ2, and θ3 of the optical axes A11, A12, and A13 to the incident surface 23a of the light guide body 23 are different from each other.

Returning to FIG. 3, also in L21, L22, and L23 which are the light beams having the same second wavelength, optical axes A21, A22, and A23 are located at different distances from the center on the incident surface 22a of the optical system 22. Accordingly, also in L21, L22, and L23 which are the light beams having the same second wavelength, the incidence angles θ1, θ2, and θ3 of the optical axes A21, A22, and A23 to the incident surface 23a of the light guide body 23 are different from each other.

Similarly, also in L31, L32, and L33 which are the light beams having the same third wavelength, optical axes A31, A32, and A33 are located at different distances from the center on the incident surface 22a of the optical system 22. Accordingly, also in L31, L32, and L33 which are the light beams having the same third wavelength, the incidence angles θ1, θ2, and θ3 of the optical axes A31, L32, and A33 to the incident surface 23a of the light guide body 23 are different from each other.

When the optical axes of light beams exited from the laser light sources 21 are located at the same distance from the center (at the positions of dashed lines in FIG. 3) on the incident surface 22a of the optical system 22, the incidence angles of the optical axes to the incident surface 23a of the light guide body 23 are located at the same position. Accordingly, in light beams having the same wavelength, the incidence angles of the optical axes to the incident surface 23a of the light guide body 23 are all different, and, meanwhile, in light beams having equal incidence angles of the optical axes to the incident surface 23a of the light guide body 23, the wavelengths are all different.

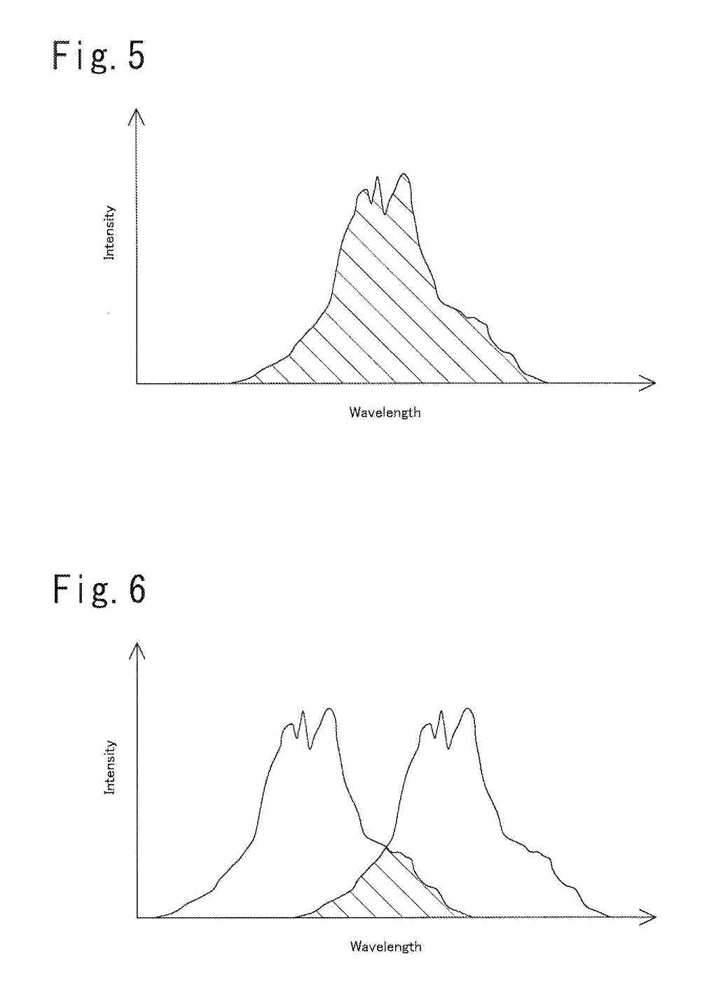

Here, “light beams having different wavelengths” and “light beams having equal wavelengths” in this embodiment will be described by referring to FIGS. 5 and 6.

As shown in FIG. 5, a spectrum (a graph showing wavelength-spectral intensity) is calculated so that an area is 1 with respect to a light beam exited from each of the laser light sources 21. Since the spectrum shown in FIG. 5 is a spectrum of the laser semiconductor 211 constituted of a plurality of (for example, 24) light emitting portions (emitters), a concavoconvex shape is shown.

As shown in FIG. 6, whether two light beams have an equal wavelength or different wavelengths is determined by calculating an area of an overlapping portion of two light spectra (oblique line portion in FIG. 6). Specifically, when the area of the overlapping portion is not more than 0.24, it is determined that the light beams have different wavelengths. Preferably, when the area of the overlapping portion is not more than 0.07, it is determined that the light beams have different wavelengths. More preferably, when the area of the overlapping portion is not more than 0.07 and a peak wavelength is separated by not less than an average value of a full width at half maximum of the spectrum, it is determined that the light beams have different wavelengths. When the area of the overlapping portion is more than 0.24, it is determined that the light beams have an equal wavelength.

In this embodiment, in two light beams, when a difference of the incidence angles of the optical axes to the incident surface 23a of the light guide body 23 is not less than 2°, “the incidence angles are different”. Preferably, in two light beams, when the difference of the incidence angles of the optical axes to the incident surface 23a of the light guide body 23 is not less than 5°, “the incidence angles are different”. More preferably, in two light beams, when the difference of the incidence angles of the optical axes to the incident surface 23a of the light guide body 23 is not less than 8°, “the incidence angles are different”. In two light beams, when the difference of the incidence angles of the optical axes to the incident surface 23a of the light guide body 23 is less than 2°, “the incidence angles are equal”.

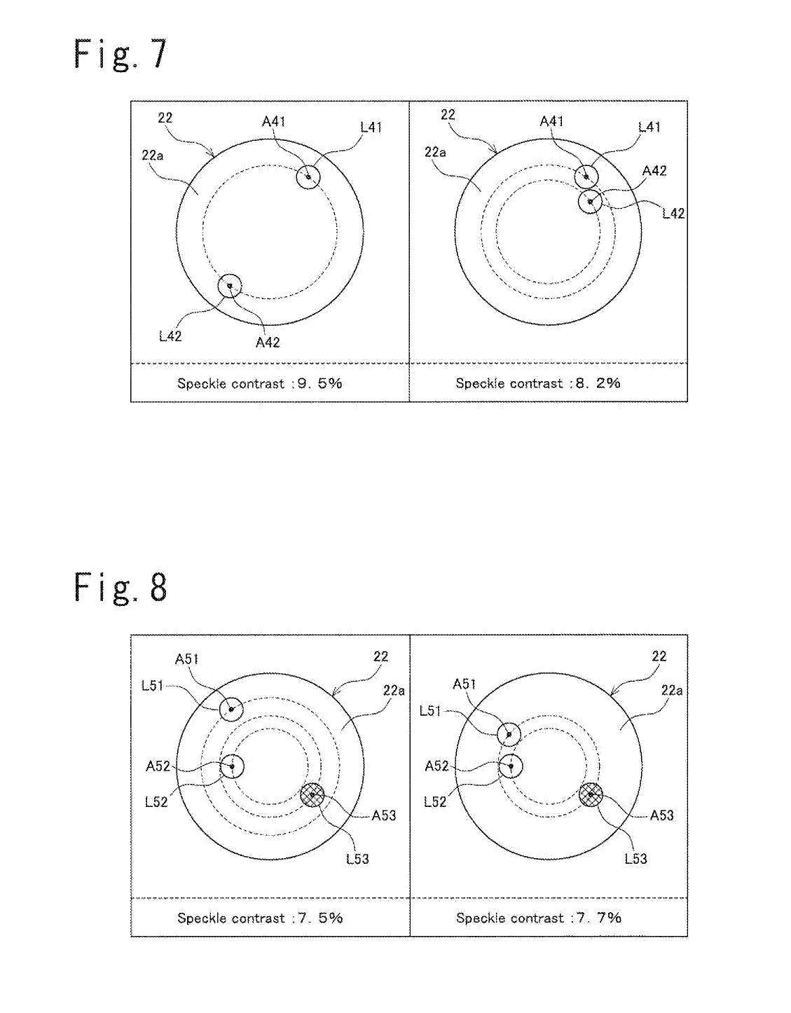

Next, the advantages of the laser light source device 2 according to this embodiment will be verified by referring to FIGS. 7 and 8. FIGS. 7 and 8 show each light incident position to the incident surface 22a of the optical system 22, as in FIG. 3.

For verification, a light beam exited from the laser light source device 2 is made incident on a rod integrator, an image at an end surface of the rod integrator is enlarged about 100 times and projected onto a screen 100, and the screen 100 is photographed by a CCD camera, whereby speckle contrast is measured from the image projected onto the screen 100. The speckle contrast is obtained by dividing a standard deviation of light intensity in each pixel of CCD by an average value of the light intensity in each pixel and is an index in which the higher the speckle contrast, the more significant variation in light intensity (speckle noise).

As shown in FIG. 7, a case where the same two light beams L41 and L42 having a wavelength of 530 nm exist will be verified. When optical axes A41 and A42 of the respective light beams L41 and L42 having the same wavelength are located at the same distance from the center on the incident surface 22a of the optical system 22, that is, when the incidence angles of the optical axes A41 and A42 to the incident surface 23a of the light guide body 23 are equal, the speckle contrast is 9.5%.

Meanwhile, when the optical axes A41 and A42 of the respective light beams L41 and L42 having the same wavelength are located at different distances from the center on the incident surface 22a of the optical system 22, that is, when the incidence angles of the optical axes A41 and A42 to the incident surface 23a of the light guide body 23 are different, the speckle contrast is 8.2%. Consequently, in light beams having the same wavelength, when the incidence angles of the optical axes to the incident surface 23a of the light guide body 23 are different, the speckle noise can be reduced.

As shown in FIG. 8, a case where the same two light beams L51 and L52 having a wavelength of 530 nm and a light beam L53 having a wavelength of 534 nm exist will be verified. When optical axes A51 to 53 of the respective light beams L51 to 53 are located at different distances from the center on the incident surface 22a of the optical system 22, that is, when the incidence angles of the optical axes A51 to A53 to the incident surface 23a of the light guide body 23 are all different, the speckle contrast is 7.5%.

Meanwhile, when the optical axes A51 and A53 of the light beams L51 and L53 having different wavelengths are located at the same distance from the center on the incident surface 22a of the optical system 22, that is, when the incidence angles of the optical axes A51 and A53 of the light beams L51 and L53, having different wavelengths, to the incident surface 23a of the light guide body 23 are equal, the speckle contrast is 7.7%. Consequently, in light beams in which the incidence angles of the optical axes to the incident surface 23a of the light guide body 23 are equal, when the wavelengths are different, occurrence of the speckle noise can be reduced.

According to the above configuration, according to the image projection device 1 and the laser light source device 2 according to this embodiment, light beams exited from a plurality of the laser light sources 21 are incident on the optical system 22, and light beams exited from the optical system 22 are incident on the incident surface 23a of the light guide body 23. In the light beams exited from a plurality of the laser light sources 21, the incidence angles of the optical axes to the incident surface 23a of the light guide body 23 are different. Consequently, the speckle noise can be reduced.

Further, the image projection device 1 and the laser light source device 2 according to this embodiment are each provided with three laser light sources 21 exiting light beams having the same wavelength. In the light beams L11 to L13 (L21 to L23 and L31 to L33) exited from the laser light sources 21, the incidence angles θ1, θ2, and θ3 of the optical axes A11 to A13 (A21 to A23 and A31 to A33) to the incident surface 23a of the light guide body 23 are all different. Consequently, the speckle noise can be more effectively reduced.

Furthermore, the image projection device 1 and the laser light source device 2 according to this embodiment are each provided with three laser light sources 21 exiting light beams in which the incidence angles θ1 (θ2) (θ3) of the optical axes L11, L21, and L31 (L12, L22, and L32) (L13, L23, and L33) to the incident surface 23a of the light guide body 23 are equal. The laser light sources 21 all exit light beams having different wavelengths. Consequently, a sufficient amount of light is allowed to be incident on the light guide body 23, and, at the same time, the occurrence of the speckle noise can be reduced.

The present invention is not limited to the configuration of the aforementioned embodiment and the aforementioned advantages. In this invention, it goes without saying that various changes and modifications may be made without departing from the spirit and scope of the invention. For example, it also goes without saying that the configuration and methods of the following various modified examples may be arbitrarily selected and adopted into the configuration and methods of the aforementioned embodiment.

The image projection device 1 according to the above embodiment is configured to be provided with the three laser light source devices 2R, 2G, and 2B. However, the image projection device 1 according to the present invention is not limited to this configuration. For example, the image projection device 1 according to this invention may be configured to be provided with one laser light source device 2, two laser light source devices 2, or four or more laser light source devices 2.

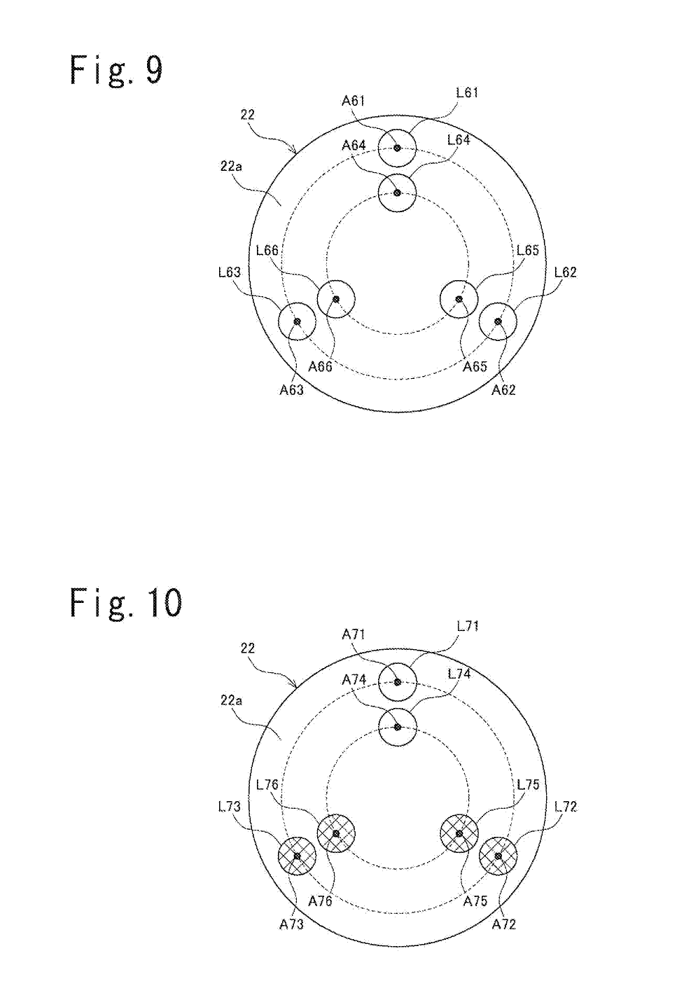

Meanwhile, the laser light source device 2 according to the above embodiment is configured that a plurality of the laser light sources 21 exit light beams having a plurality of wavelengths. However, the laser light source device 2 according to the present invention is not limited to this configuration. For example, the laser light source device 2 according to the present invention may be configured that the plurality of laser light source 21 exit light beams L61 to L66 all having equal wavelengths, as shown in FIG. 9.

FIG. 9 shows the incident positions of the light beams L61 to L66 to the incident surface 22a of the optical system 22, as in FIG. 3. FIG. 9 shows that the six light beams L61 to L66 having the same wavelength are incident on the incident surface 22a of the optical system 22.

In the above configuration, not only light beams in which the incidence angles of optical axes A61 (A62, A63) and A64 (A65, A66) to the incident surface 23a of the light guide body 23 are different but also light beams in which the incidence angles of the optical axes A61 to A63 (A64 to A66) to the incident surface 23a of the light guide body 23 are equal may exist. Needless to say, only the light beams in which the incidence angles of the optical axes to the incident surface 23a of the light guide body 23 are different may exist.

The laser light source device 2 according to the above embodiment is configured that in light beams having the same wavelength, the incidence angles of the optical axes to the incident surface 23a of the light guide body 23 are different. However, the laser light source device 2 according to the present invention is not limited to this configuration. For example, as shown in FIG. 10, the laser light source device 2 according to this invention may be configured that among light beams L72, L73, L75, and L76 having equal wavelengths, in the light beams L72 and L73 (L75 and L76), the incidence angles of the optical axes to the incident surface 23a of the light guide body 23 are equal.

FIG. 10 shows the incident positions of the light beams L71 to L76 to the incident surface 22a of the optical system 22, as in FIG. 3. FIG. 10 shows that the two light beams L71 and L74 each having the first wavelength and the four light beams L72, L73, L75, and L76 each having the second wavelength are incident on the incident surface 22a of the optical system 22.

The laser light source device 2 according to the above embodiment is configured that light beams in which the incidence angles of the optical axes to the incident surface 23a of the light guide body 23 are equal all have different wavelengths. However, the laser light source device 2 according to the present invention is not limited to this configuration. For example, as shown in FIG. 10, the laser light source device 2 according to this invention may be configured that among the light beams L71 to L73 in which the incidence angles of the optical axes to the incident surface 23a of the light guide body 23 are equal, the light beams L71 and L72 (L73) may have different wavelengths.

Further, the laser light source device 2 according to the above embodiment is configured to be used in the image projection device 1. However, the laser light source device 2 according to the present invention is not limited to this configuration. For example, the laser light source device 2 according to this invention may be configured to be used in an exposure device which performs exposure using laser light.

Further, the laser light source device 2 according to the above embodiment is configured to be provided with the optical system 22. However, the laser light source device according to the present invention is not limited to this configuration. For example, the laser light source device according to this invention may be configured that the optical system 22 is not provided and a laser light exited from the laser light source 21 directly is incident on the incident surface 23a of the light guide body 23.

Furthermore, the laser light source device 2 according to the above embodiment is configured to be provided with the light guide body 23. However, the laser light source device according to the present invention is not limited to this configuration. For example, the laser light source device according to this invention may be configured that the light guide body 23 itself is not provided, and a connecting portion removably connecting the light guide body 23 is provided.

### DESCRIPTION OF REFERENCE SIGNS

1 . . . image projection device, 2, 2R, 2G, and 2B . . . laser light source device, 3 . . . spatial modulation element, 4 . . . color synthesis optical element, 5 . . . optical image projection mechanism, 21 . . . laser light source, 22 . . . optical system, 22a . . . incident surface, 23 . . . light guide body, 23a . . . incident surface, 23b . . . exit surface, 100 . . . screen, 211 . . . semiconductor laser, 212 . . . collimate lens

1. A laser light source device comprising:
a plurality of laser light sources from which laser beams of the same color exit; and
a light guide body having an incident surface on which the light beams exited from the plurality of laser light sources are incident,
wherein at least two of the plurality of laser light sources exit light beams having the same wavelength, and
in at least two of the light beams having the same wavelength, incidence angles of optical axes to the incident surface are different.

2. A laser light source device comprising:
a plurality of laser light sources from which laser beams of the same color exit; and
an optical system on which light beams exited from the plurality of laser light sources are incident and which exits the light beams toward an incident surface of a light guide body,
wherein at least two of the plurality of laser light sources exit light beams having the same wavelength, and
the plurality of laser light sources and the optical system are configured that in at least two of the light beams having the same wavelength, incidence angles of optical axes to the incident surface are different.

3. The laser light source device according to claim 1,
wherein in the light beams having the same wavelength, the incidence angles of the optical axes to the incident surface are all different.

4. The laser light source device according to claim 1,
wherein in the light beams exited from at least two of the plurality of laser light sources, the incidence angles of the optical axes to the incident surface are equal, and the at least two laser light sources exit light beams having different wavelengths.

5. The laser light source device according to claim 1,
wherein the light guide body is an optical fiber or a rod integrator.

6. An image projection device comprising at least one laser light source device according to claim 1 and using a light beam exited from the laser light source device as projection light.

7. The laser light source device according to claim 2,
wherein in the light beams having the same wavelength, the incidence angles of the optical axes to the incident surface are all different.

8. The laser light source device according to claim 2,
wherein in the light beams exited from at least two of the plurality of laser light sources, the incidence angles of the optical axes to the incident surface are equal, and the at least two laser light sources exit light beams having different wavelengths.

9. The laser light source device according to claim 2,
wherein the light guide body is an optical fiber or a rod integrator.

10. An image projection device comprising at least one laser light source device according to claim 2 and using a light beam exited from the laser light source device as projection light.

11. A laser light source device comprising:
a plurality of laser light sources from which laser beams of the same color exit; and
a light guide body having an incident surface on which the light beams exited from the plurality of laser light sources are incident,
wherein in light beams exited from at least two of the plurality of laser light sources, incidence angles of optical axes to the incident surface are equal, and the at least two laser light sources exit light beams having different wavelengths.

12. A laser light source device comprising:
a plurality of laser light sources from which laser beams of the same color exit; and
an optical system on which light beams exited from the plurality of laser light sources are incident and which exits the light beams toward an incident surface of a light guide body,
wherein in light beams exited from at least two of the plurality of laser light sources, incidence angles of optical axes to the incident surface are equal, and the at least two laser light sources exit light beams having different wavelengths.

13. The laser light source device according to claim 11,
wherein light beams in which the incidence angles of the optical axes to the incident surface are equal all have different wavelengths.

14. The laser light source device according to claim 11,
wherein the light guide body is an optical fiber or a rod integrator.

15. An image projection device comprising at least one laser light source device according to claim 11 and using a light beam exited from the laser light source device as projection light.

16. The laser light source device according to claim 12,
wherein light beams in which the incidence angles of the optical axes to the incident surface are equal all have different wavelengths.

17. The laser light source device according to claim 12,
wherein the light guide body is an optical fiber or a rod integrator.

18. An image projection device comprising at least one laser light source device according to claim 12 and using a light beam exited from the laser light source device as projection light.
